(19) United States
(12) Patent Application Publication
(10) Pub. No.: US 2013/0307466 A1
(43) Pub. Date: Nov. 21, 2013

(54) System and Method for Charging Car Batteries

(71) Applicants: Thomas Frisch, Boeblingen (DE); Holger Lochner, Ludwigsburg (DE); Brian McBeth, Esslingen (DE); Ralf Oestreicher, Sindelfingen (DE); Christoph Saalfeld, Eisenach (DE); Tim Schluesener, Stuttgart (DE); Patrick Wolf, Starzach Bierlingen (DE)

(72) Inventors: Thomas Frisch, Boeblingen (DE); Holger Lochner, Ludwigsburg (DE); Brian McBeth, Esslingen (DE); Ralf Oestreicher, Sindelfingen (DE); Christoph Saalfeld, Eisenach (DE); Tim Schluesener, Stuttgart (DE); Patrick Wolf, Starzach Bierlingen (DE)

(73) Assignee: Daimler AG, Stuttgart (DE)

(21) Appl. No.: 13/822,058

(22) PCT Filed: Dec. 3, 2011
(86) PCT No.: PCT/EP2011/006066

§ 371 Date: Aug. 2, 2013

(30) Foreign Application Priority Data
Jan. 15, 2011 (DE) 10 2011 008 676.5

(51) Int. Cl. B60L 11/18

(52) U.S. Cl. CPC B60L 11/1846; B60L 11/1824
USPC 320/106

(57) ABSTRACT

A system for charging vehicle batteries has a number of charge devices, each arranged in an associated vehicle for charging a battery of the respective vehicle. The charge devices determine a charge profile for the associated battery and to transmit it to a charge management unit. The charge management unit references the transmitted charge profiles to determine a power distribution to the charge devices.

### BACKGROUND AND SUMMARY OF THE INVENTION

Exemplary embodiments of the present invention relate to a system and method for charging batteries in vehicles, particularly in electric or partially electric vehicles.

Such a system for charging batteries in vehicles relates at least to most charge devices that are fitted in a corresponding vehicle for charging a battery of that vehicle (what are referred to as onboard chargers).

U.S. Patent Publication US 2009/0174365 A1 discloses a network-controlled charge transfer device for transferring charge between a local power grid and an electric vehicle comprising: an electrical receptacle configured to receive an electrical connector for connection to the electric vehicle; an electric power line connecting the local power grid to the receptacle; a control device on the electric power line, for switching the receptacle on and off; a current measuring device on the electric power line, for measuring current flowing through the receptacle; a controller configured to operate the control device and to monitor the output from the current measuring device; a transceiver connected to the controller, the transceiver being configured to connect the controller to a local area network for access to a remote server via a wide area network; and a communication device connected to the controller, the communication device being configured to connect the controller to a mobile wireless communication device, for communication between the operator of the vehicle and the controller, wherein the controller is configured to manage charge transfer based on power grid load data, the power grid load data being available from the remote server, and wherein charge transfer may be in either direction between the local power grid and the electric vehicle.

European Patent Publication EP 0 820 653 B1 also discloses a method for charging a battery for an electric vehicle using a charging station, from where the charging energy is delivered to the battery, wherein the method is characterized, inter alia, by the steps according to which a means of communication is produced that can transfer data on the state of charge of the battery being charged between the battery and the charging station, and according to which the vehicle is interrogated via the means of communication in order to determine whether a battery-specific charge control module is provided and is associated with the battery in the vehicle; wherein the method also comprises the step that, if a battery-specific charge control module is provided in the vehicle, the battery is charged through delivery of charging current under the control of the battery-specific charge control module and the delivery of charging current to the battery is stopped in response to a corresponding signal emitted by the battery-specific charge control module.

Exemplary embodiments of the present invention provide a system and a method for charging batteries installed in vehicles (particularly electric vehicles), which are used to power the vehicles, which system and method allowing efficient account to be taken of the vehicle's requirements and efficient account to be taken of the needs, state of charge and intended use of the vehicle concerned.

Accordingly, provision is made for the charge devices in each case to be designed to determine a charge profile for the associated battery and transmit it to a central, possibly remote charge management unit that is designed, at least by reference to the charge profiles transmitted, to determine a power distribution to the charge devices. A charge profile is understood here to refer to the charge capacity over time.

Exemplary embodiments of the present invention therefore relate to a system or a device in which charge control originates from the connected electric vehicles. In this case, the vehicle is connected to a connecting means (for example in the form of a power cable) to an electrical connection (for example a socket in a charging column) of a charging station. These electrical connections are connected via a power supply line (or a number of power supply lines) to a mains supply of a grid of a power supply company (PSC). The vehicle's charge device (onboard charger) preferably communicates here either through “Power Line Communication” (PLC), which involves data transfer over already existing communication networks, in particular power grids, in which the signals are usually also modulated to the respective line via one or more carrier frequencies, or via a wireless communication link (through network access) to the charge management unit (computer).

An onboard application in the respective charge device then determines the mains power available, preferably from the respective electrical connection (in particular ISO 61851), and reports this, preferably together with a need-based charge profile, to the charge management unit.

In charge management or the charge management unit, what is referred to as an offboard application (in other words an application provided outside the vehicle or the charge device) then preferably determines, on the basis of the reported charge profiles and mains power specifications, a power distribution to the reported and connected vehicles and their charge devices.

Preferably, for communication between the charge devices and the charge management unit the system according to the invention has a first means of communication connected to the power supply line, in particular in the form of a PLC modem, which is equipped and provided to establish a wireless communication link, in particular in the form of an Ethernet connection, via which the charge devices can be connected to the charge management unit.

Herein, so that the charge devices can communicate with the charge management unit, the system preferably has a second means of communication, that is to say in particular in the form of a DSL router, which is designed to establish an Internet connection with the charge management unit, via which the charge devices can be connected to the charge management unit.

This also means that a charge protocol can be routed to a separate charge management system so that charge management can be carried out as a service function irrespective of geographical access to the network and the location of the charging columns.

Through the abovementioned second means of communication, it is also easily possible for the system according to the invention to manage or have a multiplicity of charging stations, in particular in different places, wherein the individual charge devices (vehicles) are in turn connectable to those stations in each case via a connecting means each having an electrical connection (in particular ISO 61851) and in each case via the second means of communication to the charge management unit (server). Here, if applicable, in each case a local control unit for controlling the communication between the respective charging station and the charge management unit is provided between the first means of communication and the second means of communication of a charging station.

The occupancy of the electrical connections of the at least one charging station is preferably detected via PLC or via an occupancy detection unit of the at least one charging station, which, for detecting occupancy, for example, has at least one inductive baseplate that is arranged such that a vehicle connected as intended to an electrical connection is arranged on (over) that baseplate and the presence of the vehicle or the occupancy of an electrical connection can therefore be detected.

The charge management unit (offboard application) is preferably also equipped and provided to compare the sum of the power needs of a charging station corresponding to the transmitted charge profiles with the mains power in each case available at that charging station.

Provided that sum of reported power needs does not exceed the mains power specifications, all reported needs can be served as requested. If too great a need is reported, the power is preferably allocated to the individual vehicles by the charge management unit (offboard application).

Here, the charge management unit is preferably equipped and provided, in the event that the sum exceeds the mains power available in each case at the charging stations, to distribute the power to vehicles connected at a charging station as a function of the time the vehicles arrived at the respective charging station, wherein, of two vehicles, the charge device of that vehicle that arrived earliest is allocated power first.

This allocation principle is what is known as the “first come, first served” principle. Alternatively, vehicle prioritization based on fleet management (departure time, range requirement, minimum charge requirement, for example, in refrigerated vehicles, premium customer conditions, or rapid charge options) can be used as an allocation principle.

Therefore, the charge management unit is preferably equipped and provided, in the event that the sum exceeds the mains power available in each case at the charging stations, to distribute the power to the charge devices of the vehicles as a function of the departure time of a vehicle, the range requirement of a vehicle, the minimum charge requirement of a vehicle, the customer status of a vehicle and/or the rapid charge option of a vehicle.

Moreover, a method is provided for charging batteries in vehicles, in particular using a system according to the invention, wherein the vehicle determines charge profiles for the batteries to be charged and transmits them to a central, possibly remote charge management unit, by means of which, at least by reference to the transmitted charge profiles, power distribution to the vehicles is determined.

Preferably, the vehicle also determines that the mains power of an electricity grid of a PSC that is used is available to charge the respective battery and transmits this together with the charge profiles to the charge management unit, by means of which a power distribution to the respective vehicle is determined by reference to the transmitted charge profiles and the mains power available.

A further aspect of the invention relates to an (onboard) method for charging a vehicle battery, wherein the vehicle is connected to a charging station in order to charge the battery to a target state of charge, this method involves the steps of: determining, by the vehicle, a first charge profile as a function of a maximum power rating of the charging station, a target state of charge and a predefined charge period, and checking by the vehicle as to whether the target state of charge can be achieved within the predefined charge period.

In other words, the vehicle therefore makes available to a corresponding application, in particular comprising an optimization algorithm, a first charge profile that includes the time curve for any charging and, if applicable, the associated development of the target state of charge and takes account therein of the requirements of the battery in terms of possible power consumption and of the vehicle's charge device in terms of any possible power output.

The vehicle can generate a further, second charge curve via continuous communication with a charge management unit of a mains supply of the charging station by reference to a maximum power profile for the charge period that is provided by the charge management unit and is available (on a continual basis) at the charging station, and to check whether the target state of charge can be achieved with it, i.e. the optimization algorithm adjusts the initial (first) charge profile (time curve of charging) to the physical power limits of the charging station and of the connecting means (for example cable etc.) used to connect the vehicle to the charging station, generating a further (second) charge profile.

The vehicle preferably also checks whether any other available power profiles provided with tariff profiles are available from the charge management unit.

A charge profile and the costs thereof corresponding to the tariff profile associated in each case is preferably determined by the vehicle here for each of the tariff profiles offered and the vehicle checks whether the target state of charge can be achieved with the respective charge profile, wherein preferably that charge profile is called up by the vehicle from the charge management unit with which the target state of charge can be achieved on the basis of the lowest costs.

The respective charge profile is preferably synchronized (in terms of time) with time-segmented tariff profiles of a power supplier providing the mains supply with energy, so that a corresponding time-segmentation of the relevant charge profile is generated (discretization of the charge profile by reference to sampling points by segmentation). If need be, additional time segments may be determined in order to achieve improved optimization possibilities in the future.

By reference to the tariff profiles, the vehicle then preferably determines a maximum power profile available at the charging station, which takes account of the physical limits of the charging station and, if applicable, of the charge device and other components, wherein the maximum power profile has the same time-segmentation (discretization) as the individual tariff profiles.

Here, a state of charge prognosis is preferably calculated by the vehicle (onboard) at least as a function of the current state of charge, of the characteristics of the vehicle battery and/or of the maximum power profile, wherein that state of charge prognosis is used to determine whether the vehicle can be charged fully to the (predefinable) target state of charge within the charge period available.

In the event that the vehicle cannot be fully charged to the (predefinable) target state of charge within the charge period available, the generated maximum power profile is consequently used as the charge profile for controlling the charge process.

If, on the other hand, the battery can be sufficiently charged using the maximum power profile, the vehicle preferably checks whether, on the basis of an incentive signal from the power supplier providing the mains supply of the charging station with energy, there is a cheaper option for achieving the target state of charge, wherein each time segment resulting from the time segmentation is provided with a cost element (cost factor) based on the incentive signal, this element resulting from the product of the available power, the duration of that power and any predefinable incentive factor of the power supplier.

Furthermore, the vehicle preferably examines, by reference to all time segments and by reference to all tariff profiles offered, which power change achieves the greatest cost advantage in a time segment compared to the (current) maximum power profile, wherein the vehicle examines whether this power change still achieves the target state of charge.

In the event that the target state of charge can no longer be achieved with the power change, the power change is preferably not carried out and the cost elements are adjusted accordingly.

If, however, the target state of charge can be achieved with the power change, the power change is preferably carried out by the vehicle at the maximum power profile and the cost elements are adjusted accordingly.

If, by reference to the cost elements, no further power change can be determined with which the target state of charge can still be favorably achieved, the charge profile determined in such a way is preferably used to control the battery charging process. Otherwise, it is again checked onboard, by reference to all of the time segments and by reference to all of the tariff profiles offered, which power change achieves a cost advantage in a time segment compared to the (current) maximum power profile, wherein the vehicle checks whether this power change still achieves the target state of charge.

Finally, the charge profile determined by the optimization described above is preferably transmitted to the charging station and the power supplier.

The onboard method described above therefore advantageously enables the processing of incentive signals in connection with current vehicle information and customer specifications in order to control the process of charging batteries installed in vehicles in accordance with requirements.

A further concept of the invention relates to an (offboard) method in which, in a first step, a communication link and vehicle identification is established between the charge management unit and a control unit in the connected vehicle, in a further step charge management transmits an electronic data structure with time curves of possible available charge capacities and price signals for the individual available charge capacities to the control unit in the vehicle, and, in a further step, charge management reads the data structure returned by the control unit of the vehicle on a charge curve determined by the vehicle and provides the power profile requested by the vehicle by means of the charge curve at the charging column (electrical connection).

Price signals for the individual available charges are preferably transmitted to the control unit by the charge management unit together with the available charge capacities, wherein the charge curve to be transmitted to the charge management unit is also determined by the control unit as a function of the price signals that are associated with the available charge capacities.

Any remaining charge capacity still available in each case is preferably offered to the vehicle that is connected after the at least one vehicle to an electrical connection of the charging station. The remaining charge capacity available (power) is determined by the charge management unit here preferably by reference to a signal transmitted from the at least one vehicle to the charge management unit. In a variation of the invention, part of the available charge capacity always to be set aside as reserve capacity for any urgent need.

The available charge capacity can also be provided by the charge management unit to the at least one electrical connection of the charging station as a function of further consumers that are also hooked up to the same grid as the at least one electrical connection of the charging station.

In the event that a power profile requested by the at least one vehicle exceeds a maximum mains power available at the electrical connection, the provision of charge capacity to at least one further vehicle and/or the at least one vehicle is preferably at least temporarily interrupted by the charge management unit. That interruption can, for example, be carried out as a function of a predefinable minimum state of charge (minimum SOC) of the vehicles, a tariff model, a priority class of the vehicles, a standing time (length of time waiting at the charging station) of the vehicles, and/or a connection time (length of time connected at the charging station) of the vehicles.

The charge management unit preferably first at least temporarily interrupts the provision of charge capacity to at least one of those vehicles whose state of charge exceeds the predefinable minimum state of charge (capacity).

Furthermore, in a variation of the invention, the charge management unit initially, at least temporarily, interrupts the provision of charge capacity to at least one of those vehicles whose standing time falls below or exceeds a predefinable limit standing time. In addition, in a variation of the invention, the charge management unit initially, at least temporarily, interrupts the provision of charge capacity to at least one of those vehicles whose connection time falls below or exceeds a predefinable limit connection time.

As a result, the method therefore offers the particular advantage that the power can be distributed flexibly to the required charge profiles. The charge profiles can, from the customer's perspective, be adjusted flexibly to the current state of charge of the vehicle and to the tariff structures of the power supplier and to the respective network capacity. Different tariffs, for example for rapid charging, can be offered through price signals here. In addition, preferential conditions may be offered for premium customers, such as charging at preferable times. Accounting can advantageously be automated through vehicle identification.

### BRIEF DESCRIPTION OF THE DRAWING FIGURES

Further features and advantages of the invention or of the further inventive concepts are explained by reference to the figures in the following description of the exemplary embodiments, in which:

FIG. 1 shows a schematic representation of a system for charging vehicle batteries;

FIG. 2 shows a schematic representation of a deviation from the system shown in FIG. 1;

FIG. 3 shows a schematic representation of a deviation from the system shown in FIG. 2;

FIG. 4 shows a graphic representation of an initial (first) charge profile adjusted to the power rating, along with the associated development over time of the state of charge of the vehicle battery to be charged in an onboard method;

FIG. 5 shows a graphic representation of a (second) charge profile adjusted to an actually available maximum power profile, along with the associated (adjusted) development of the state of charge over time;

FIG. 6 shows a graphic representation of tariff profiles for adjusting a charge profile, along with a corresponding development of the state of charge over time;

FIG. 7 shows a graphic representation of a number of possible (charge) power profiles for different tariff profiles, along with corresponding target state of charge prognoses, which characterize the respective optimization potential of the onboard method;

FIG. 8 shows a graphic representation of an optimization of a charge profile through reduction of the charge capacity;

FIG. 9 shows a graphic representation of an optimization of a charge profile through reduction of the charge capacity;

FIG. 10 a graphic representation of a completed optimization of a charge profile through reduction of the charge capacity;

FIG. 11 shows a graphic representation of an optimization of a charge profile through reduction of the charge capacity;

FIG. 12 a graphic representation of a completed optimization of a charge profile through reduction of the charge capacity;

FIG. 13 shows a graphic representation of an optimization of a charge profile through partial reduction of the charge capacity;

FIG. 14 shows a graphic representation of an initial optimization of a charge profile (without price information);

FIG. 15 shows a graphic representation of an optimization step in an optimization according to FIG. 14;

FIG. 16 shows a graphic representation of an optimization step in an optimization according to FIG. 14;

FIG. 17 shows a graphic representation of an optimization step in an optimization according to FIG. 14;

FIG. 18 shows a graphic representation of an optimization step in an optimization according to FIG. 14;

FIG. 19 shows a graphic representation of an optimization step in an optimization according to FIG. 14;

FIG. 20 shows a graphic representation of an optimization step in an optimization according to FIG. 14;

FIG. 21 shows a graphic representation of a distribution of charge capacity to a first vehicle according to the “first come, first served” principle in an offboard method;

FIG. 22 shows a graphic representation of a distribution of charge capacity to a second vehicle according to the “first come, first served” principle; and

FIG. 23 shows a graphic representation of a distribution of charge capacity to a third vehicle according to the “first come, first served” principle.

### DETAILED DESCRIPTION

In accordance with exemplary embodiments of the present invention, the system for charging car batteries includes a central authority in the form of a charge management unit directly communicating with vehicles 10-13, which are e-drive vehicles, whose batteries are to be charged, via a charge protocol (for example ISO/IEC 15118).

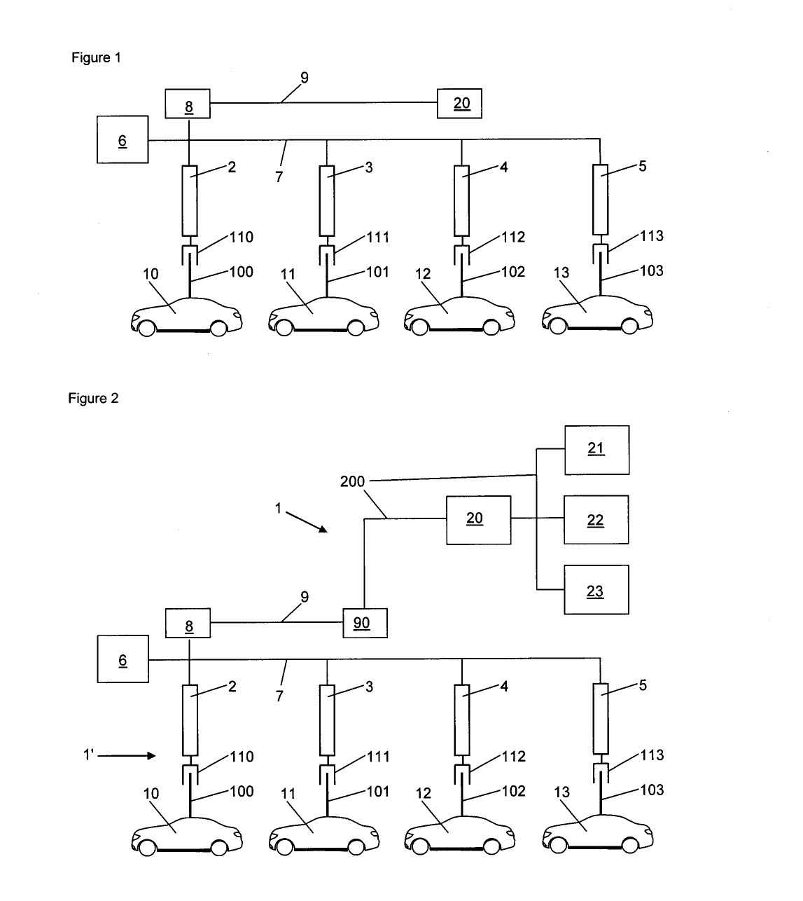

For this purpose the infrastructures and systems 1 shown in FIGS. 1 to 3 for the performance of charge management illustrate exemplary embodiments of the present invention. Prerequisites for this are a communication protocol, a vehicle-based (onboard) and an offboard application each having a corresponding algorithm.

According to FIG. 1, vehicles 10-13 to be charged are each connected via a connecting means 100-103 in the form of a power cable to a respective electrical connection 110-113, for example in the form of a socket, provided at a charging column 2-5 of a charging station 1′. The electrical connections 110-113 or charging columns 2-5 are connected here via a power supply line 7 to a mains supply 6 of a grid supplied by a power supply company.

The vehicles 100-103 connected to the charging columns 2-5 of the charging station 1′ communicate here via PLC. For this purpose, in the area of the charging columns 2-5, a first means of communication 8 in the form of a PLC modem is provided, which is coupled to the power supply line 7 and converts the communication to an Ethernet connection 9 to a charge management unit 20, which can be carried out using a computer.

The charge management authority 20 (charge management unit) produces a TCP/IP connection with the vehicles 100-103 connected. Using the IP addresses of the individual vehicles 100-103, those vehicles 100-103 can now be addressed.

The vehicles 100-103 identify themselves through a clear identification. The charge management authority 20 communicates with each vehicle 100-103 individually via a charge protocol and also contains central components, such as a charge management algorithm, vehicle monitoring, charge monitoring, external interfaces, etc.

The occupancy of the charging station 1′ can optionally be established via the PLC communication or via alternative vehicle presence recognition, for example using inductive baseplates under the vehicles.

The individual charging columns 110-113 themselves are not direct participants in the PLC charge communication. Instead, the communication takes place via the PLC communication 8 described above and the Ethernet connection 9 between a charge device of a vehicle 100-103 connected to the respective charging column, which serves to charge the battery installed in the vehicle 100-103, and the charge management unit 20.

The connected charge devices in each case determine a charge profile (charge capacity over the course of time) for the associated battery and transmit it to the charge management unit 20 together with the mains power available at the respective charging column 2-5.

The latter determines (offboard), by reference to the transmitted charge profiles and associated mains power, a power distribution to the individual charge devices or vehicles 100-103 connected to the charging station 1′ and ensures the corresponding provision of charge capacity at the charging columns 2-5.

The local electrical connections 110-113 of a vehicle fleet (or of a charging station 1′ with a charge management unit 20) have access to connections according to IEC61851-1. All connections within a charging station 1′ have access to the same power levels or transmit their power limit according to IEC61851-1 to the connected vehicles 100-103, which in turn make this information available to the charge management unit 20. Safety functions remain at the local charging columns or wall boxes 2-5 (for example temperature monitoring, current monitoring). Individual electrical connections 110-113 do not need to be accounted for within a unit 1′.

The advantage of this system and method lies in the fact that multiple arrangements for communicating with individual charging columns 2-5 are unnecessary and therefore costs can be saved.

Furthermore, the charge management unit 20 can be separated by connecting the PLC modem 8 via Ethernet 9 to a DSL router 90 according to FIG. 2 and can be addressed via an Internet connection 200. This also allows easy communication between the charge management unit 20 (server) and corresponding servers of a power supplier 21 being used, of any fleet management 22 and, if applicable, of an operating reserve exchange 23 via Internet connections 200.

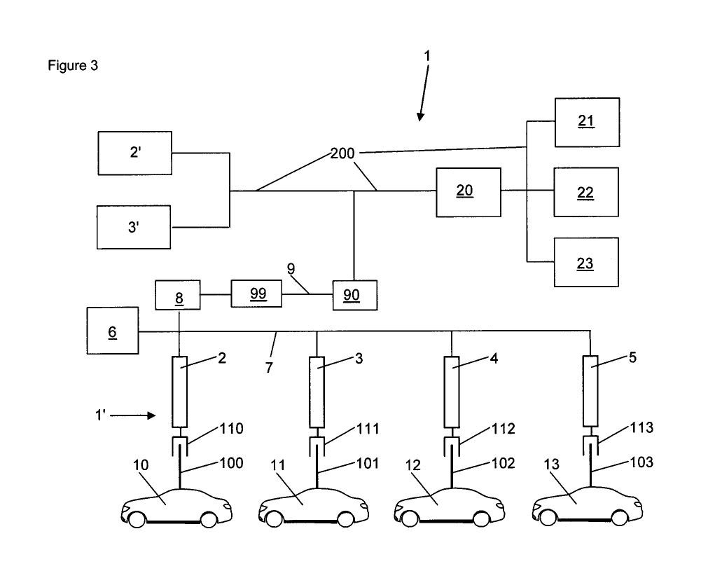

The system 1 can also easily be modularized because a number of charging stations 1′-3′ as in FIG. 2 can be connected to one another according to FIG. 3 via the respective DSL routers 90, so that a central charge management unit 20 communicates with the individual charging stations 1′-3′ via Internet connections 200. Here, the individual charging stations 1′-3′ can, if applicable, have local control units 99 between the PLC modems 8 and the DSL routers 99, which, if applicable, can take on the responsibilities of the central charge management unit 20.

By means of the system 1, the vehicles 10-13 in a local fleet can be charged in good time through optimal distribution of the resources available according to the need for availability of the vehicles 10-13.

Moreover, a simple connection to the IT infrastructure 22 of a fleet operator is possible (cf. FIG. 3). This makes fleet management more efficient.

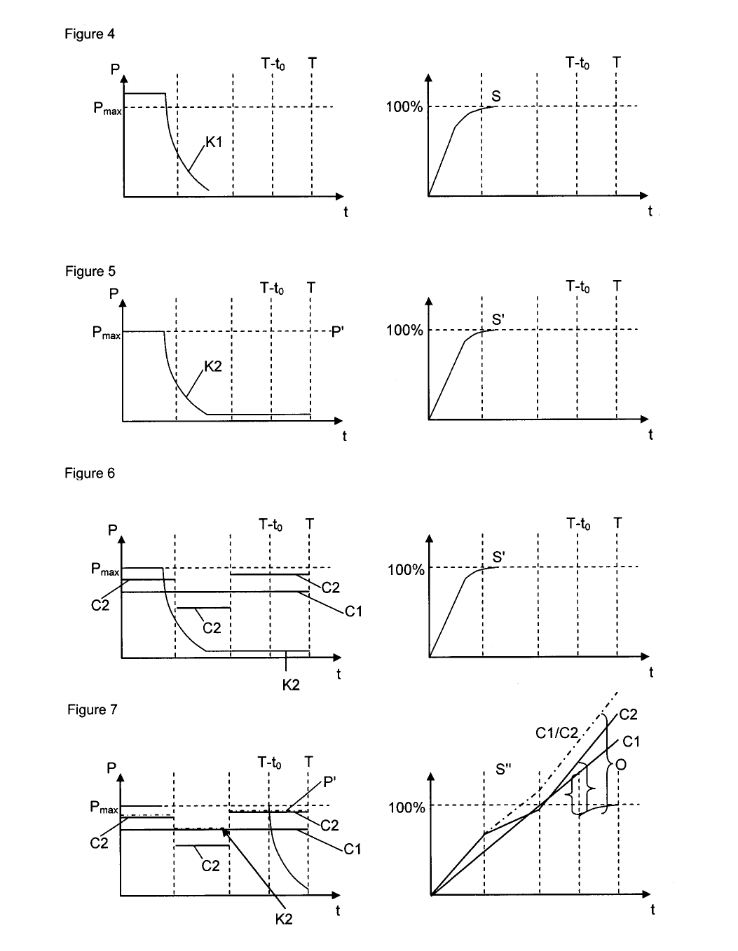

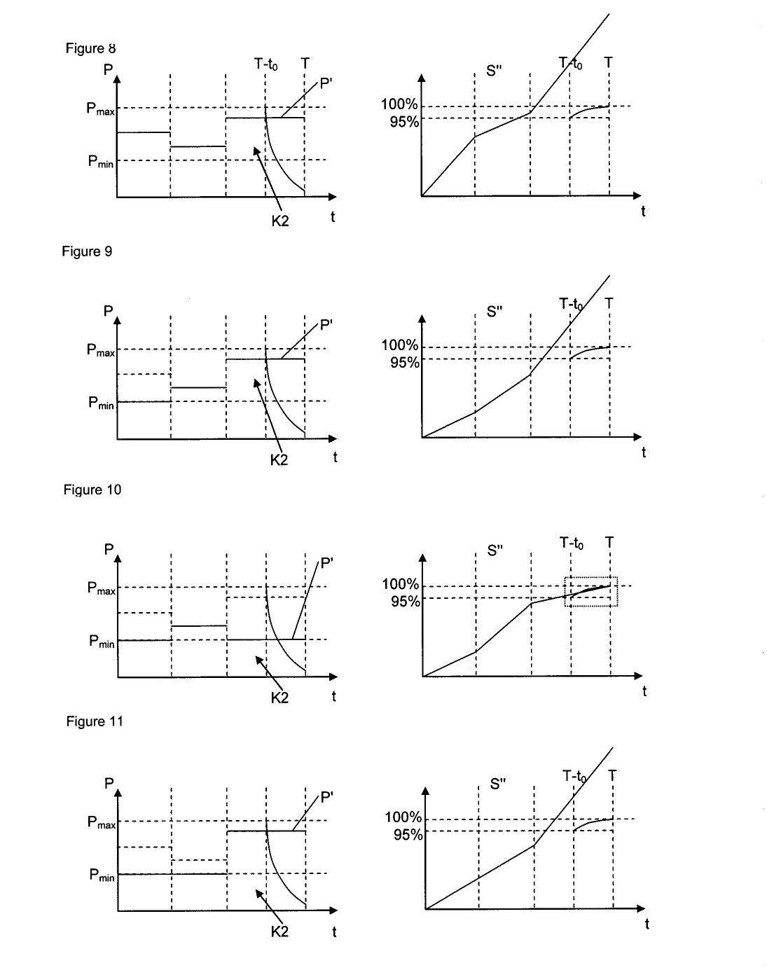

In an onboard method according to FIGS. 4 to 20, it is possible to charge vehicle batteries as required, that is to say in particular taking account of customer requirements (departure time, range), vehicle requirements (ageing of components, protective strategies, physical framework conditions, power data, internal resistance, efficiency factors, power loss, temperature, etc.), network requirements (physical framework conditions of the connection, network capacity, status of the network segment to which the vehicle is connected, price of electricity, operating reserve requirement and emergency situations) and charge station requirements or charge cable requirements (max. current in charge cable, max. current in charging station, number of phases, etc.).

In order to enable a vehicle battery to be charged in such a way as required, the respective vehicle first makes an initial first charge profile K1 according to FIG. 4 available to an onboard optimization algorithm which, for example, can be implemented in a control device of the vehicle, in particular in an onboard charger (charge device). This profile defines a time curve for a charge capacity P, which determines the associated development of the state of charge S (SOC) (at 100%, the battery is fully charged). Here the requirements of the battery in respect of any possible power consumption and of the charge device in respect of any possible power loss are taken into account.

The optimization algorithm then, according to FIG. 5, adjusts the initial (first) charge profile K1 to the physical power limits Pₘₐₓ of the charging station and of the connecting means (cable) used to connect the vehicle to the charging station. This means, in the example according to FIG. 5, a lowering of power to the maximum available power Pₘₐₓ and an extension of the corresponding power profile P′ to the total charge period T. The target state of charge S′ is reached in FIG. 5 correspondingly early before the actual charge period T. In FIGS. 4 to 20, to refers to the charge time in a charging process with constant voltage if the maximum charge capacity is available.

There takes place, according to FIGS. 6 and 7, a synchronisation of the charge profile K2 in terms of time with the tariff information of the power supplier, which may be provided in the form of tariff profiles C1 and C2. These show additional sampling points in the charge profile K2 (at the vertical dotted lines), which are the result of power/price changes in the tariff information (C1, C2). Here, C1 and C2 designate the power limits of the corresponding tariff, wherein it should be assumed that the costs are in each case proportional to the power limit.

This shows a first segmentation of the charge capacity offer P over time t. If need be, additional time segments can be determined in order to improve optimization possibilities in the future.

The tariff information offered is used to determine a maximum power profile P′ which takes account of the physical limits. This maximum power profile P′ has the same time discretization as the individual tariffs C1 and C2.

An SOC prognosis S″ is determined on the basis of the current state of charge (SOC), the battery characteristics of the vehicle and the maximum power profile P′. This SOC prognosis S″ shown in FIG. 7 (on the right) is used to determine whether the vehicle can be fully charged or can be charged up to the target state of charge defined by the user in the available time T. The optimization potential can be identified by reference to the difference O from the target state of charge S′ in the charge period T. If charging cannot be guaranteed in time (within the predefined charge period T), then the optimization algorithm is brought to an end and the generated maximum charge profile P′ or K2 is used for controlling the charging process.

If sufficient charging of the battery is possible by reference to the maximum power profile P′ or charge profile K2 (as on the right in FIG. 7), then the optimization algorithm investigates whether, on the basis of the incentive signal of the power supplier (PSC), there is a more favorable option for achieving the charge target.

For this purpose, each time segment along the time axis t can, on the basis of the incentive signal, be provided with a cost element which, for example, may result from costs=service*duration*incentive.

Then, all time segments and all offered tariffs are searched to see which power change compared to the respective maximum power profile P′ achieves the greatest cost advantage. It is then examined whether this power change still achieves the user's charge target. If not, the power change is not an option and the cost elements are adjusted accordingly. If so, the power change is achieved in the maximum power profile P′ and the result is a new maximum power profile P′ or charge profile K2. The cost elements are correspondingly adjusted and the optimization process is repeated (cf., for example, FIGS. 8 to 10).

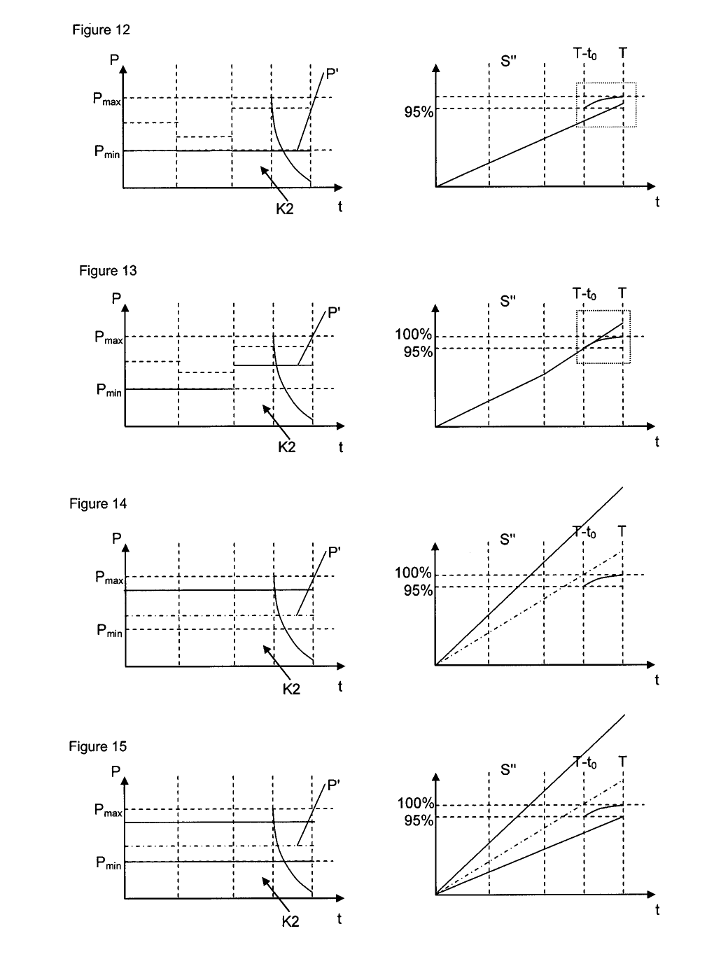

If, for example, according to FIG. 12, the charge target is not achieved, i.e. there is no intersection between the calculated charge curve S″ in the range from 95% to 100% and the predefined (ideal) charge curve shifted to the range from T-t₀ to T, which achieves 100% state of charge at T, then, in this case, for example, the charge capacity can be increased in the segment currently considered (at P′), which, according to FIG. 13, leads to the desired intersection within the range.

After optimization has been carried out, i.e. there is, by reference to the cost elements, no further optimization potential by which the charge target can still be achieved (cf., for example, FIGS. 10 and 13), the calculated charge profile K2 is used to control the charge process. The calculated charge profile K2 is still sent to the charging station and the power supplier.

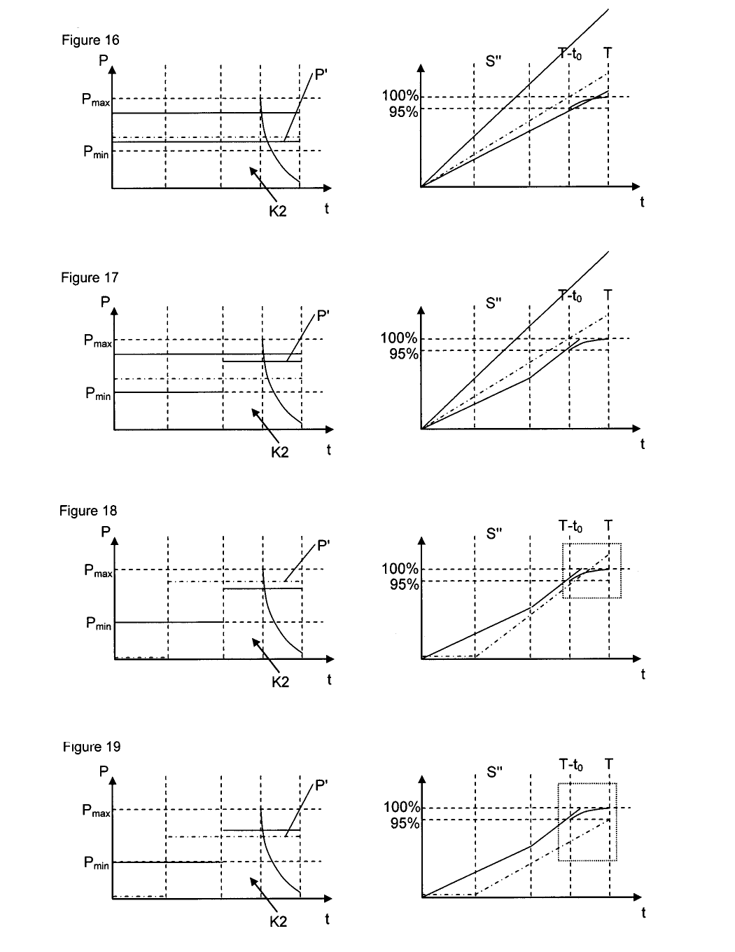

FIGS. 14 to 20 also show optimization in which no segment-like price information is initially provided. According to FIG. 14, for example, the charge target can be achieved here with the two shown constant power profiles P′ in the range from Pₘₐₓ to Pₘᵢₙ (solid and dot-dashed line). A following power change for optimization of the power profile P′ leads to a time curve of the state of charge S″ that does not exceed the 95% threshold during the charge period T. Accordingly, the charge capacity is now constantly increased according to FIG. 16 so that the desired intersection occurs and the optimization can be concluded (on the right in FIG. 16).

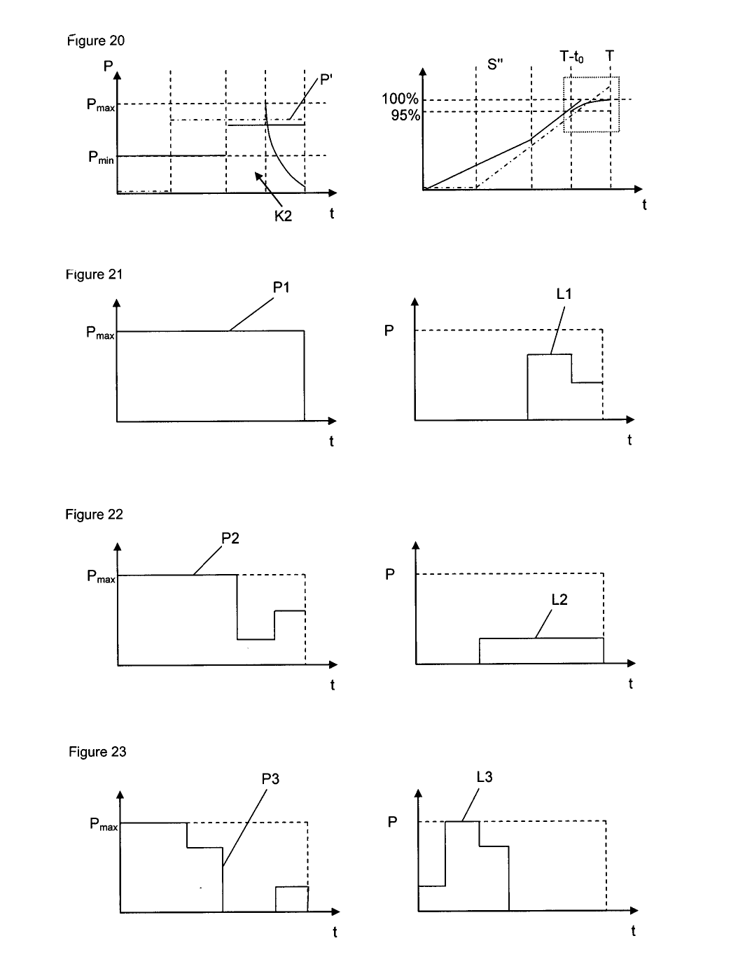

FIG. 17, on the other hand, shows a further optimization strategy in which the charge capacity P is to be increased at the latest possible time in the charging process. A corresponding power change according to FIG. 17 does not produce the desired intersection in this case (cf. on the right in FIG. 17), so that, according to the strategy, the time to increase power is accelerated, which leads to the desired optimization result, cf. power profile P′ in FIG. 18. Here, the specifications of the PSC are sufficient. In the power change according to FIG. 19, however, there is no intersection in the range from T-t₀ to T (dot-dashed state of charge curve according to P′ or K2). In this case, the power limits are not enough to charge the battery as the customer wishes. In this case, a steady increase in the corresponding segment (see power profile P′ in FIG. 20) is carried out, which leads to the desired intersection in the present case (state of charge curve S″ goes through the range from 95% to 100%, T-t₀ to T, cf. FIG. 20, right-hand side). The corresponding expedient power change is notified to the PSC in order to inform the latter of the specifications with which the charge can be completed as desired.

Through the offboard method or a corresponding algorithm according to FIGS. 21 to 23 a number of vehicles can be charged taking account of the most diverse influencing variables. The vehicles are controlled via a communication protocol (for example ISO 15118). The method aims to ensure that maximum power that is available at a charging station or a charging column of this station is not exceeded. Here, network capacity information, electricity prices, emergency situations and an operating reserve requirement can basically be taken into account from the perspective of a PSC. In fleet management, for example, the prioritization of vehicles, the range requirement of vehicles, the departure time of vehicles, the power data of vehicles, and the meeting of minimum requirements in special vehicles such as, for example, refrigerated vehicles, can be applied as input variable of the method (influences). For car park operators, for example, a premium customer status, rapid charging options or different business models, for example premium parking spaces receive electricity under preferable conditions, long-stay customers park for free because costs are covered by proceeds from the operating reserve, can be applied as input variables of the method (influences).

Different charging strategies can be derived from the above influencing variables. For example, based on what is known as the “first come, first served” principle, the remaining power capacity available in each case power is offered to the newly arriving vehicle, the vehicle response being used to determine the remaining power available.

The charge management required to do this can be achieved in the form of a charge management unit behind charging columns of a charging station. Through the grid, each vehicle connected by a charging cable to the charging station can establish a communication with the charge management unit.

After establishing a PLC (Power Line Communication) connection between a connected vehicle and the charge management unit, the offboard side (charge management unit) sends two tables to that vehicle. One table contains the available charge capacity P1 and the second table contains a price signal at the respective times t.

The price table contains information from the power supply company which is supposed to make charging more or less attractive at certain times t. The available charge capacity depends on the capacity of the mains supply of the charging station and the other consumers connected.

If vehicles are already connected to the charge management unit, then the charge capacity taken up by them (charge curves L1-L3 in FIGS. 21 to 23) at any time t is deducted from the total available power P1-P3 and this “new maximum charge curve” P1-P3 is sent to the arriving vehicle.

The vehicle then calculates the actual charge curve L1 to L3 for the vehicle by reference to the onboard algorithm implemented in its control unit (for example charge device). The vehicle in turn sends this charge curve L1 to L3 back to the charge management system. The charge capacity L1-L3 taken up by the arriving vehicle is then taken into account in charge management for the recalculation of the maximum available charge capacity P1-P3.

For example, according to FIG. 21, there is initially no vehicle at the charging station, so a constant maximum power Pₘₐₓ is available at a charging column. FIG. 21 shows, on the right-hand side, the charge curve L1 calculated by a first vehicle connected to the charging station by reference to the charge capacity P1=Pₘₐₓ=const transmitted by the charge management unit with which that first vehicle will now be charged. This charge curve L1 is reported back to the charge management unit, which calculates therefrom the charge capacity P2=Pₘₐₓ−L1 available to the next (subsequent) second vehicle (cf. FIG. 2)

By reference to this charge capacity P2, the second vehicle determines its charge curve L2 and reports this back so that P3=P2−L2 is now available as the charge capacity at the charging column (cf. FIG. 3). The third vehicle calculates its charge curve L3 from this.

Such use of the offboard method enables the efficient charging of vehicles whose total charge capacity exceeds the power rating. At the same time, a reduction in infrastructural costs and a reduction in electricity costs are achieved by leveling the load and by avoiding load peaks. This allows the simple operation of fleets of electric vehicles (charging is an integral part of fleet operation because charging times are similar to driving times) and also provides a basis for the business models of car park operators connected with electric vehicles. It also allows the desired use of renewable energy despite fluctuating supply.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-15. (canceled)

16. A system for charging vehicle batteries, the system comprising:
a charge management unit; and
a plurality of charge devices, each arranged in an associated vehicle and each configured to charge a battery of the respective vehicle,
wherein the charge devices are each configured to determine a charge profile for an associated battery and transmit the determined charge profile to the charge management unit, and
wherein the charge management unit is configured to determine a power distribution to the charge devices using the transmitted charge profiles.

17. The system according to claim 16, the system further comprising:
a charging station, wherein each of the plurality of charge devices are respectively connected via connecting means to an electrical connection of the charging station, wherein the electrical connection of the charging station is a socket of a charging column of the charging station, wherein the electrical connections are connected to a mains supply via a power supply line of the charging station.

18. The system according to claim 17, wherein the charge devices are configured to determine a mains power available at the electrical connections of the charging station and to transmit the determined mains power to the charge management unit, and wherein the charge management unit is configured to determine a power distribution to the charge devices using the transmitted charge profiles and the available mains power.

19. The system according to claim 18, wherein the charge devices are configured to transmit the charge profiles or the available mains power, to communicate with the charge management unit via the power supply line of the charging station using power line communication (PLC) or a wireless communication link.

20. The system according to claim 17, wherein in order to communicate between the charge devices and the charge management unit the system includes a power line communication (PLC) modem of the charging station connected to the power supply line, the PLC modem is configured to establish a wireless communication link as an Ethernet connection via which the charge devices are connected to the charge management unit.

21. The system according to claim 20, wherein in order to communicate between the charge devices and the charge management unit the system further includes a digital subscriber line (DSL) router of the charging station, the DSL router is configured to establish an Internet connection with the charge management unit via which the charge devices are connected to the charge management unit.

22. The system according to claim 21, wherein the system comprises a plurality of charging stations arranged in different locations, wherein the individual charge devices respectively connected via the socket of a charging column of the respective charging station to the electrical connection of one of the charging stations, wherein the electrical connections of each charging station are connected to the mains supply via the power supply line, and wherein the charging stations are each connected to the charge management unit via the DSL router and the Internet connection.

23. The system according to claim 22, wherein a local control unit configured to control the communication between the respective charging station and the charge management unit is respectively arranged between the PLC modem and the DSL router of the respective charging station.

24. The system according to claim 17, wherein occupancy of the electrical connections of the at least one charging station is detected via power line communications (PLC) or via an occupancy detection unit of the respective charging station, and wherein the occupancy detection unit includes at least one inductive baseplate arranged such that a vehicle connected to the respective electrical connection is arranged on the respective baseplate.

25. The system according to claim 18, wherein the charge management unit is configured to compare a sum of power needs of a charging station corresponding to the respective transmitted charge profiles with the available mains power.

26. The system according to claim 25, wherein the charge management unit is configured to distribute power to the respective vehicles of the charging station in a predefined manner if the sum exceeds the available mains power.

27. The system according to claim 26, wherein when sum exceeds the mains power available the charge management unit is configured to distribute the power to the charge devices of the vehicles of a charging station as a function of the time a vehicle arrived at the respective charging station so that a vehicle that arrived earliest is allocated power first.

28. The system according to claim 26, wherein when the sum exceeds the mains power available the charge management unit is configured to distribute the power to the charge devices of the vehicles of a charging station as a function of
a departure time of a vehicle,
a range requirement of a vehicle,
a minimum charge requirement of a vehicle,
a customer status of a vehicle, or
a rapid charge option of a vehicle.

29. A method for charging vehicle batteries, the method comprising:
determining, by a vehicle charge device, a charge profile for an associated battery of the vehicle;
transmitting, by the vehicle to a charge management unit, the determined charge profile; and
determining, by the charge management unit, a power distribution to the vehicle charge device using the transmitted charge profile.

30. The method according to claim 29, further comprising:
determining, by the vehicle, a mains power that is available to charge the associated battery, wherein the vehicle transmits the determined mains power together with the charge profile to the charge management unit, wherein the charge management unit determines the power distribution to the vehicle using the transmitted charge profile and the available mains power.
